(19) United States
(12) Patent Application Publication
(10) Pub. No.: US 2019/0172329 A1
(43) Pub. Date: Jun. 6, 2019

(54) SECURITY SYSTEM AND METHOD

(71) Applicants: LUCIS TECHNOLOGIES HOLDINGS LIMITED, Grand Cayman (KY); LUCIS TECHNOLOGIES (SHANGHAI) CO., LTD., Shanghai (CN)

(72) Inventor: Defeng SHI, Shanghai (CN)

(73) Assignees: LUCIS TECHNOLOGIES HOLDINGS LIMITED, Grand Cayman (KY); LUCIS TECHNOLOGIES (SHANGHAI) CO., LTD., Shanghai (CN)

(21) Appl. No.: 16/253,313

(22) Filed: Jan. 22, 2019

Related U.S. Application Data
(63) Continuation of application No. PCT/CN2016/090975, filed on Jul. 22, 2016.

(51) Int. Cl. G08B 13/196; H04N 7/18; G06T 7/13; G08B 21/18; G01V 8/00

(52) U.S. Cl. CPC G08B 13/19602; H04N 7/183; G06T 7/13; G06T 2207/30196; G01V 8/005; G06T 2207/30232; G08B 21/182

(57) ABSTRACT

The present disclosure discloses a system including a detection module configured to receive a microwave signal from a moving object located in an environment and obtain at least one optical image including the moving object; and a processor configured to determine frequency information associated with the environment according to the a microwave signal, determine a contour of the moving object according to the at least one optical image, and determine a security level according to at least a portion of the frequency information and the contour of the moving object.

### CROSS REFERENCE TO RELATED APPLICATIONS

This application is a continuation of International Application No. PCT/CN2016/090975 filed on Jul. 22, 2016, the entire contents of which are hereby incorporated by reference.

### TECHNICAL FIELD

The present disclosure relates to a security system, in particular, a security system for identifying human intrusion with microwave signals and/or optical signals.

### BACKGROUND

In recent years, the security problems in different places, in particular, are human intrusion problems, which have attracted people's attention. A security system is needed to automatically process the environmental monitoring information in real time and to determine the security conditions.

### SUMMARY

According to one aspect of the present disclosure, a system is provided. The system includes a detection module configured to receive a microwave signal from a moving object located in the environment, and obtain at least one optical image containing the moving object; a processor configured to determine frequency information associated with the environment according to the microwave signal, determine a contour of the moving object according to the at least one optical image, and determine a security level according to at least a portion of the frequency information and a contour of the moving object.

According to another aspect of the present disclosure, a method is provided. The method includes receiving a microwave signal from a moving object located in the environment; obtaining at least one optical image including the moving object; determining, by the processor, frequency information associated with the environment based on the microwave signal; determining the contour of the moving object according to the at least one optical image.

According to still another aspect of the present disclosure, a computer readable storage medium is provided for storing executable instructions. The executable instructions are caused to be executed by a computing device, including receiving a microwave signal from a moving object located in the environment; obtaining at least one optical image including the moving object; determining frequency information associated with the environment according to the microwave signal; determining a contour of the moving object according to the at least one optical image; determining a security level according to at least a portion of the frequency information and a contour of the moving object.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTIONS OF THE DRAWINGS

The drawings described herein are used to provide a further understanding of the present disclosure and form a part of the present disclosure. The illustrative embodiments of the present disclosure and the description thereof are used to explain the present disclosure and do not constitute a limitation of the present disclosure.

FIG. 1 is a schematic diagram of an applications scenario of a security system according to some embodiments of the present disclosure;

FIG. 2 is a schematic block diagram of a security system according to some embodiments of the present disclosure;

FIG. 3 is a flowchart illustrating an exemplary process for processing the obtained surrounding environment signals according to some embodiments of the present disclosure;

FIG. 4 is a schematic diagram of a detection module according to some embodiments of the present disclosure;

FIG. 5 is a schematic diagram of a processor according to some embodiments of the present disclosure;

FIG. 6 is a schematic flow chart of an exemplary security monitoring operation according to some embodiments of the present disclosure;

FIG. 7 is a flowchart illustrating an exemplary process for processing a microwave signal according to some embodiments of the present disclosure;

FIG. 8-A is a schematic diagram illustrating a waveform of a microwave signal of a moving object in the time-domain according to some embodiments of the present disclosure;

FIG. 8-B is a schematic diagram illustrating a waveform of a microwave signal of a moving object in the frequency domain according to some embodiments of the present disclosure;

FIG. 8-C is a schematic diagram illustrating a waveform of a microwave signal of an irregularly moving object in the time-domain according to some embodiments of the present disclosure;

FIG. 8-D is a schematic diagram illustrating a waveform of a microwave signal of a irregularly moving object in the frequency domain according to some embodiments of the present disclosure;

FIG. 8-E is a schematic diagram illustrating a waveform of a microwave signal of a regularly moving object in the time-domain according to some embodiments of the present disclosure;

FIG. 8-F is a schematic diagram illustrating a waveform of a microwave signal of a regularly moving object in the frequency domain according to some embodiments of the present disclosure;

FIG. 9-A is a flowchart illustrating an exemplary process for processing an image obtained based on an image signal according to some embodiments of the present disclosure;

FIG. 9-B is a flowchart illustrating an exemplary process for of processing an image obtained based on an infrared signal according to some embodiments of the present disclosure;

FIG. 10 is a flowchart illustrating an exemplary process for a security system to determine whether there is a human intrusion based on a microwave signal and an image signal by according to some embodiments of the present disclosure; and

FIG. 11 is a flowchart illustrating an exemplary process for initiating an intervention by the security system according to some embodiments of the present disclosure.

### DETAILED DESCRIPTION

As used in the disclosure and the appended claims, the singular forms “a,” “an,” and “the” may be intended to include the plural forms as well, unless the context clearly indicates otherwise. In general, the terms “comprise” and “include” merely prompt to include operations and elements that have been clearly identified, and these operations and elements do not constitute an exclusive list. The methods or devices may also include other operations or elements. The term “based on” may be interpreted as “based at least in part on.” The term “an/one embodiment” means “at least one embodiment”; the term “another embodiment” means “at least one additional embodiment.” Relevant definitions of other terms will be given in the description below.

Although the present disclosure makes various references to certain modules in the system according to embodiments of the present disclosure, any number of different modules may be used and run in the security system. These modules are merely illustrative, and different modules may be used for different aspects of the system and method.

The flowcharts used in the present disclosure illustrate operations that systems implement according to some embodiments in the present disclosure. It is to be expressly understood, the operations above or below may not necessarily be implemented in order. Alternatively, the operations may be performed in an inverted order, or simultaneously. Besides, one or more other operations may be added to the flowcharts, or one or more operations may be removed from the flow chart.

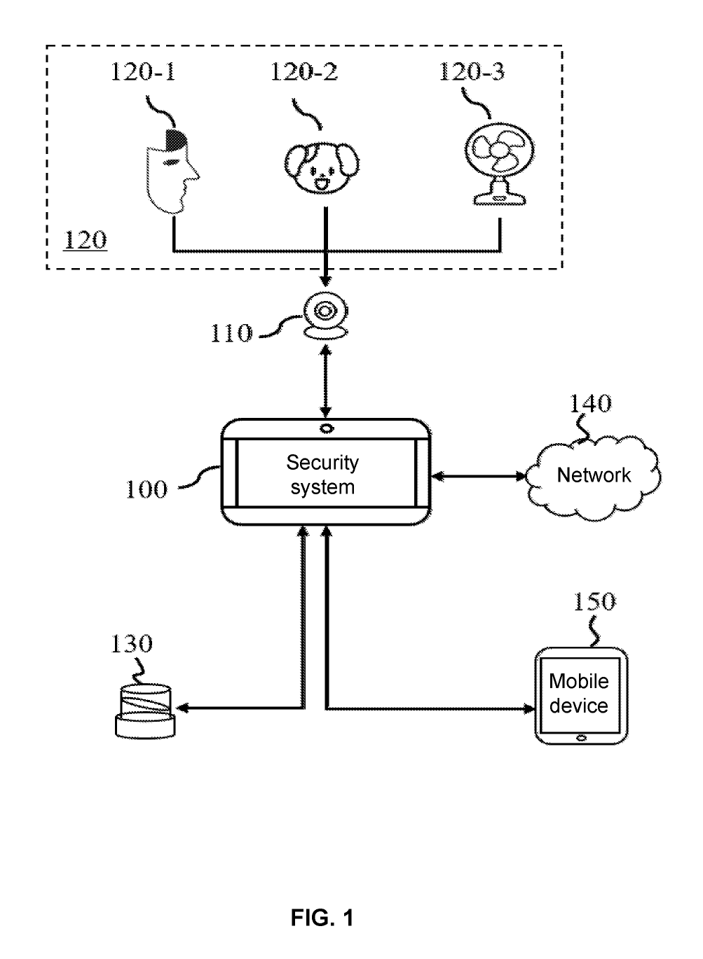

FIG. 1 is a schematic diagram of an applications scenario of a security system according to some embodiments of the present disclosure. The security system 100 may communicate with a sensor 110, an alarm 130, a network 140, and a mobile device 150.

The sensor 110 may obtain information on the surrounding environment (or be referred to as surrounding environment information). The sensor 110 may be a microwave sensor, an optical sensor, an ultrasonic sensor, a vibration sensor, a sound sensor, a gas sensor, or the like, or a combination thereof. Through the sensor 110, the security system 100 may obtain information of a moving object 120 in the surrounding environment, which may include a person 120-1, an animal 120-2, a household item 120-3 such as a fan or a curtain, etc. The security system 100 may analyze and process the obtained information to determine whether there is a human intrusion, and warn the intruder through the alarm 130. In some embodiments, the sensor 110 may include a microwave sensor, an infrared sensor (e.g., an infrared thermal imager), an image sensor, a sound sensor, a gas sensor, or the like.

The security system 100 may be connected to the network 140. The security system 100 may be connected to the network 140 in a wired manner or a wireless manner. In some embodiments, the security system 100 may transmit the obtained information or the processing result to the network 140 for sharing the information or assisting the determination. In some embodiments, the security system 100 may obtain information via the network 140 for, e.g., system upgrading, security condition adjustment, or the like. The network 140 may be a single network or a combination of multiple networks. For example, the network 140 may include a local area network (LAN), a wide area network (WAN), a public network, a private network, a wireless local area network (WLAN), a virtual network, a metropolitan network, a public switched telephone network (PSTN),or the like, or any combination thereof. The network 140 may include various network access points, such as a wired or wireless access point, a base station, or a network switching point. A data source may be connected to the network 140 through the access point. Information may be sent via the network.

The security system 100 may be connected to the mobile device 150. The security system 100 may provide the obtained information or the processing results to the mobile device 150, and receive user input from the mobile device 150. The user input may include a control command, a setting of parameters, or the like, or a combination thereof. In some embodiments, the mobile device 150 may be a mobile phone, a laptop computer, a tablet computer, a smart watch, or the like.

In some embodiments, the security system 100 may include a protective housing and an input/output (I/O) panel. The protective housing may have a certain aesthetic or hidden property, and may be water-proof, moisture-proof, shock-proof, or anti-collision. The I/O panel may provide an interface (I/O interface) for the user to input information into the security system 100 or for the security system 100 to output information to the user. In some embodiments, the I/O interface may be a touchscreen. In some embodiments, the security system 100 may be installed at an entrance or a guard room of a building, or in a living room, a hallway, or a lounge of a house.

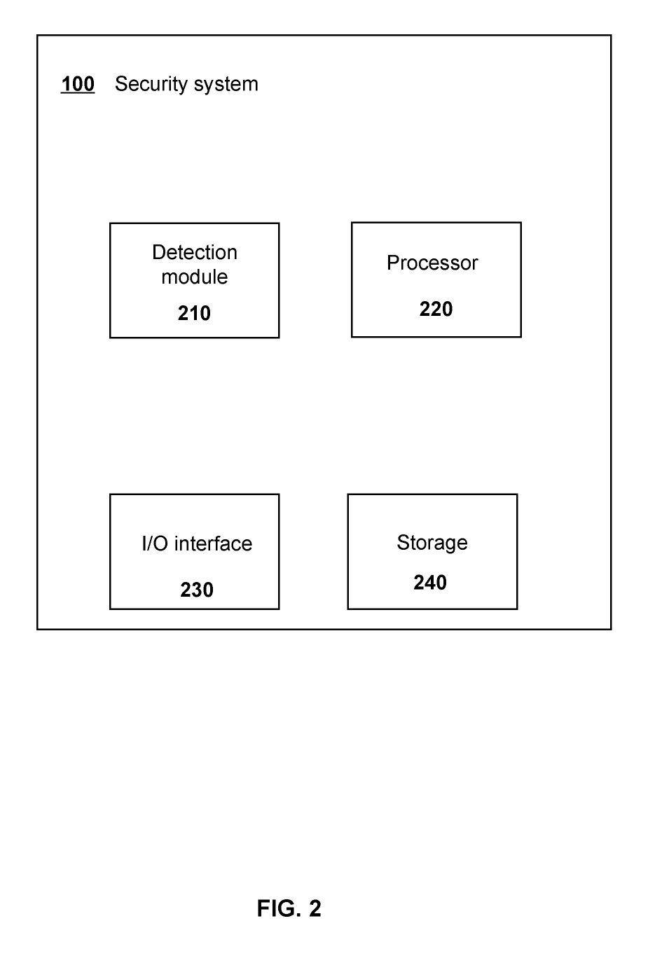

FIG. 2 is a schematic block diagram of a security system according to some embodiments of the present disclosure. The security system 100 may include a detection module 210, a processor 220, an input and output (I/O) interface 230, and a storage device 240. The connection between modules in the system may be wired or wireless. Any module may be local or remote. The correspondence between modules may be one-to-one or one-to-many. For example, the security system 100 may include a plurality of detection modules 210 and a plurality of processor 220; a processor may correspond to a detection module to process the information it obtains. As another example, the security system 100 may include a plurality of detection module 210 and a processor 220; these detection modules 210 may send information to the processor 220 for processing.

The detection module 210 may obtain the surrounding environment information obtained by the sensor 110. The detection module 210 may establish a communication connection with the one or more sensor 110, and use the sensor 110 to monitor and obtain information of the objects in the environment. The objects in the environment may be stationary objects such as a wall, a door/window, furniture, stationary appliances, etc. The objects may also be moving objects such as a rotating fan, a pendulum clock, a swaying plant, a moving animal, a person, etc. The information received by the detection module 210 may include a microwave signal, an infrared signal, an image signal, an ultrasonic signal, an audio signal, a pressure signal, etc. In some embodiments, the signal may be an unprocessed signal directly outputted by a sensor. In some embodiments, the signal may be generated by processing a signal, such as a corresponding voltage signal, a current signal, etc. For example, the signal may be a voltage signal generated by a processing element of the sensor through signal processing. The information obtained by the detection module 210 may be sent to the processor 220 for processing, stored in the storage device 240, and/or directly presented to the user through the I/O interface 230. In some embodiments, the detection module 210 may include one or more processing elements to pre-process the received information, which may then be transmitted to the processor 220 for further processing.

The processor 220 may process signals and generate decisions or instructions, etc. The processor 220 may process and/or logically analyze the received signal or information and generate control information. The received signal or information may be obtained from the surrounding environment by the detection module 210 through the sensor 110, or inputted via the I/O interface 230, or the like. The processor 220 may process the signals obtained by the detection module 210 using one or more approaches, which may include a fitting, an interpolation, a discretization, an analog-to-digital (AD) conversion, a Z transformation, a Fourier transformation, a low-pass filtering, a contour recognition, a feature extraction, an image segmentation, an image enhancement, an image reconstruction, a non-uniformity correction, a detail enhancement for infrared digital images, etc. For example, the processor 220 may extract and recognize information on the human face, the human body contour, etc., from the obtained image signal by feature extraction, contour recognition, etc. The processor 220 may also logically process the information obtained through the I/O interface 230 and generate control information. For example, after receiving instructions inputted by the user for calibrating the infrared sensor, the processor 220 may generate control information and transmit it to the infrared sensor. The control information may include one or more approaches and operations for calibrating the infrared sensor. In some embodiments, the processor 220 may process signals obtained by the detection module 210 (such as a microwave signal, an image signal (e.g., an optical image signal in the form of an optical image), an ultrasonic signal). The processor 220 may identify whether the processed information satisfies one or more security conditions based on preset security conditions. The processor 220 may also determine the security level based on the identification, and generate control information corresponding to the current security level.

In some embodiments, the processor 220 may passively receive the information. In some embodiments, according to the processing result or the instruction of the user, the processor 220 may actively obtain the surrounding environment information or request user to input such information. For example, based on the computation and image processing, the processor 220 may lock the suspect target, and generate an instruction to adjust the angle or position of the monitoring device or the sensor (such as a camera) to continue tracking and obtaining signals of the target object. As another example, the processor 220 may transmit the obtained signal or the result of the processing to the I/O interface 230 or the mobile device 150, request the user to confirm whether it is a human intrusion, and generate corresponding control information.

Processor 220 may be a processing element or device. For example, the processor 220 may include a central processing unit (CPU), a graphics processing unit (GPU), a digital signal processor (DSP), a system on a chip (SoC), a microcontroller (MCU), or the like, of a device such as a computer. As another example, the processor 220 may include a device such as a tablet computer, a mobile terminal, or a general computer. As another example, the processor 220 may be a specially designed processing element/device having a special function.

The I/O interface 230 may input information into the security system 100 or output information generated by the security system 100. The information inputted via the I/O interface 230 may include numbers, text, images, a video, sound, or the like, or a combination thereof. For example, the information may include a numerical threshold or range in the security conditions, face information, iris information, fingerprint information, voice commands, gesture instructions, or the like, or a combination thereof. The I/O interface 230 may obtain information from the user by means of a handwriting operation, a touch screen operation, a mouse operation, an operation on a button or a key, a voice control operation, a gesture operation, an eye operation, or the like. The input information may be saved to the storage device 240, or sent to the processor 220 for processing, or the like.

Through the I/O interface 230, the security system 100 may output the processing result or send a request to the user to obtain information. In some embodiments, the I/O interface 230 may be in the form of light, text, sound, image, vibration, or the like, or a combination thereof. In some embodiments, the I/O interface 230 may output information through a physical display such as a light-emitting diode (LED) indicator, a liquid-crystal display (LCD) display, an organic light-emitting diode (OLED) display, or a speaker. In some embodiments, the I/O interface 230 may output information using virtual reality technology, such as holographic images.

The I/O interface 230 may be or be included in a smart terminal such as a tablet computer, a mobile phone, a laptop computer, a smart watch, or the like. In some embodiments, the I/O interface 230 may be on the panel of the security system, such as a touch screen, an LED light, a speaker, a button, a key, or the like, or any combination thereof

In some embodiments, the I/O interface 230 may establish a connection with the network 140 and may input or output information through the network 140. In some embodiments, the I/O interface 230 may be wirelessly connected to the user mobile device 150. For example, the user may receive the information outputted by the security system 100 through the mobile device 150. As another example, a user may send a user command over the network 140 to implement remote control of the security system 100.

The storage device 240 may be used to store the information obtained and generated by the security system 100. In some embodiments, the information stored by the storage device 240 may include the surrounding environment information obtained by the detection module 210, the processing result generated by the processor 220, and the user input information received by the I/O interface 230. The information stored in the storage device 240 may be in the form of a text, a number, a sound, an image, or the like. In some embodiments, the storage device 240 may include, but not limit to, common types of storage devices such as a solid state hard disk, a mechanical hard disk, a USB flash memory, an SD memory card, an optical disk, random-access memory (RAM), and read-only memory (ROM). In some embodiments, the storage device 240 may be a storage device inside the system, an external storage device of the system, a network storage device other than the system (such as a memory on the cloud storage server,).

It should be noted that the above description of each module in the security system 100 is only a specific embodiment and should not be regarded as the only feasible solution. It will be apparent to those skilled in the art that, after understanding the basic principle of the modules, various modifications and changes may be made to the configuration of the security system 100 without departing from it. However, such corrections and changes are still within the scope of the above description.

For example, the security system 100 may also include a power module for independently powering the system to avoid the risk of a power outage. For example, the security system 100 may also include an anti-interference module for resisting interference devices carried by the intruding person, ensuring the normal functioning of the security system 100, sensors, and alarms, etc. As another example, the detection module 210 may receive a chemical signal, a light signal, a temperature signal, a humidity signal, or the like.

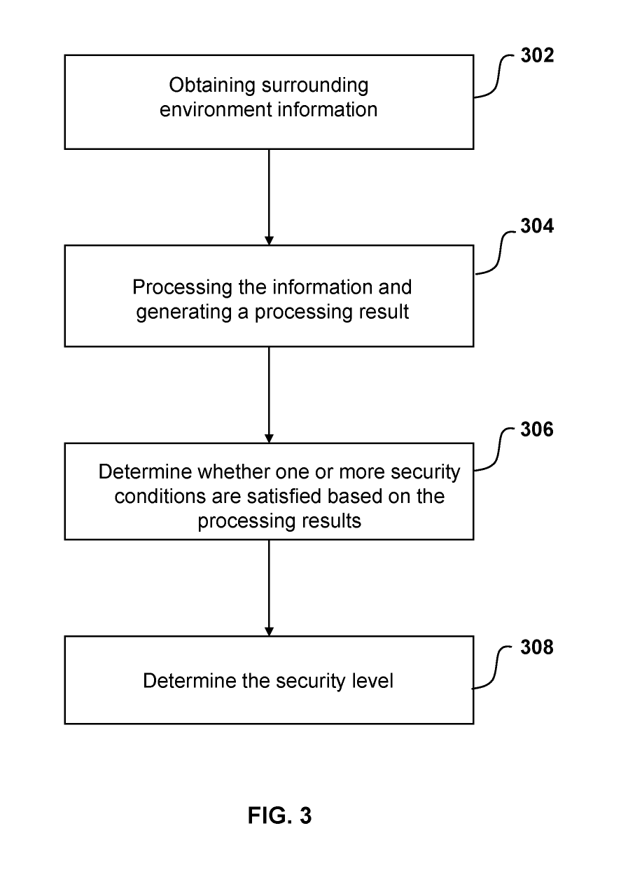

FIG. 3 is a flowchart illustrating an exemplary process for processing the obtained surrounding environment signals according to some embodiments of the present disclosure. Operation 302 may include obtaining the surrounding environment information through the sensor 110. The surrounding environment information obtained by the security system 100 may include one or more characteristics of objects in the environment. The one or more characteristics may be physical or chemical information such as the contour of the object, thermal radiation, color, sound, shape feature, motion, action feature, and odor. In some embodiments, the security system 100 may obtain a microwave signal through a microwave sensor to identify a moving object. In some embodiments, the security system 100 may obtain infrared signals by an infrared sensor to determine whether a human or an animal present in the environment. In some embodiments, the security system 100 may obtain the pressure or deformation of the door/window through the pressure sensor to determine whether the door/window is opened in a normal way, etc. In some embodiments, the security system 100 may also obtain an image of a target object through the image sensor for analyzing the shape/contour of the object.

Operation 304 may include processing, by the security system 100, the above information and generating a processing result. For different types of information, security system 100 may select different processing approaches. The approaches may include a numerical computation, a waveform processing, an image processing, or the like, or a combination thereof. The numerical computation may include a fitting, a normalization, an integration, a principal component analysis (PCA), a discretization, or the like, or a combination thereof. The waveform processing may include a Fourier transformation, a wavelet transformation, a low-pass filtering, an analog-to-digital conversion, a linear frequency modulation (FM), or the like, or a combination thereof. The image processing may include an inter-frame difference, a fuzzy recognition, an image denoising, a multi-resolution processing, a region segmentation, a histogram enhancement, a convolutional back-projection reconstruction, a model-based coding, or the like.

In operation 306, security system 100 may determine whether one or more security conditions are satisfied based on the processing result. The one or more security conditions may include a threshold corresponding to the processing result, a time/frequency-domain feature of a microwave signal, a shape/contour feature, a sound, a facial feature, or the like. In some embodiments, the one or more security conditions may include that the aspect ratio of the contour is less than 1, a temperature obtained by infrared thermal imaging is lower than 36° C., the object is moving regularly, the contour in the image doesn't belong to human, a facial/sound feature matches with that of the user, or the like, or a combination thereof. The one or more security conditions may be obtained from user's input, default information preset in the system, or adaptive adjustment by the system according to the surrounding environment information, etc.

In some embodiments, the security system 100 may transmit the obtained information or the processing result to the user or a security authority to facilitate the determination whether there is an intrusion. For example, in some special situations where security conditions are critical, the security system 100 may present the currently obtained signals such as voice, image, microwave, infrared, or the like, to the user through the user mobile device 150, or to the security device remotely through the network 140 to facilitate the determination whether there is an intrusion.

In operation 308, according to the above determination, the security system 100 may determine the current security level, which may be one of a plurality of preset security modes, such as a sleep mode, a caution mode, a threat mode, an intrusion mode, etc. The sleep mode may be used when the user is at home to reduce or avoid interference causing by activities of the user at home. The caution mode may correspond to a security level that the security system 100 keeps monitoring the surrounding environment and no abnormality is detected (for example, when there is no one at home, or at night). The intrusion mode may correspond to a security level that the security system 100 determines that there may be an intruder. The intrusion mode may correspond to a security level that the security system 100 confirms that a high-risk human intrusion occurs. The security levels described above are for illustrative purposes only and are not intended to limit the scope of the present disclosure. The security system 100 may also include other security levels.

In some embodiments, a security level may correspond to a security condition or a combination of security conditions. A security level may be determined when one or more corresponding security conditions are determined. For example, the security system 100 may identify a moving object based on the processing result of a microwave signal, determine that the temperature of the object is greater than a preset threshold based on an infrared signal, and then determine that the security level is the threat mode. As another example, the security system 100 may identify a moving object, determine that the moving object is moving regularly, and then determine that the security level is the caution mode. The correspondences between the security levels and the security conditions may be set by the user, preset as default system parameters, or adaptively adjusted by the system according to the surrounding environment, etc.

In some embodiments, the security level may be determined according to at least a portion of frequency information associated with the surrounding environment and the contour of the moving object. In some embodiments, the frequency information (e.g., information on a fixed frequency component of a moving object of the environment, a frequency-domain signal obtained after filtering out the fixed frequency component) may be determined according to a microwave signal obtained by the detection module 210 or the sensor 110. Detailed descriptions may be found elsewhere in the present disclosure.

It should be noted that the above description of the workflow of the security system 100 is only a specific embodiment and should not be regarded as the only feasible solution. Obviously, those skilled in the art, after understanding the major concept, may make various modifications and variations to the workflow or algorithm of the security system 100 in form and details without departing from it. However, such modifications and variations are still within the scope of the above description.

In some embodiments, the above process for determining whether the security condition is satisfied or violated may also be replaced by a process for identifying one or more dangerous conditions. When the processing result satisfies a predetermined dangerous condition or a combination of dangerous conditions, a security level may be determined. For example, when the signal processing result of the security system 100 satisfies a first dangerous condition that the aspect ratio of the contour is greater than 1 and a second dangerous condition that the temperature obtained by infrared thermal imaging is higher than 36° C., the security system 100 may determine that the security level is the intrusion mode. As another example, when the signal processing result of the security system 100 satisfies a dangerous condition that the object is moving irregularly, then the security system 100 may determine that the current security level is the threat mode, and further check other dangerous conditions until a final security level is determined.

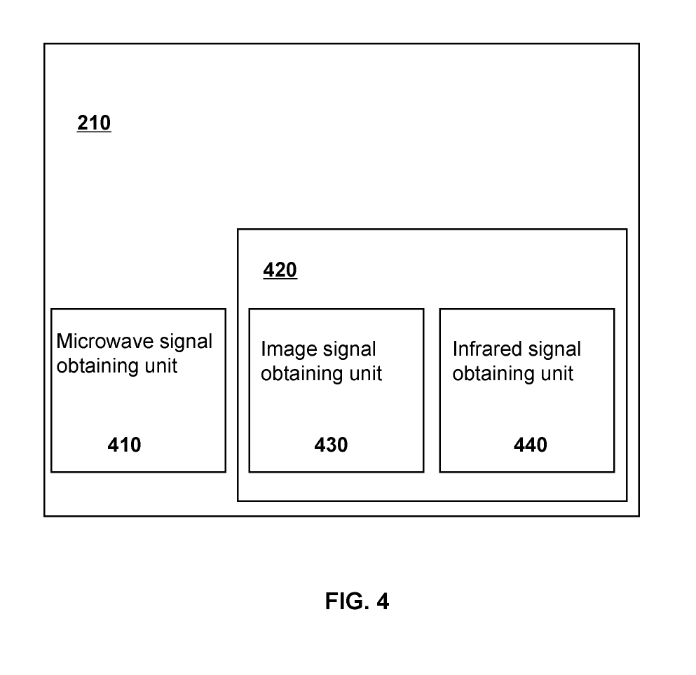

FIG. 4 is a schematic diagram of a detection module according to some embodiments of the present disclosure. The detection module 210 may include a microwave signal obtaining unit 410 and an optical signal obtaining unit 420. The optical signal obtaining unit 420 may further include at least one of infrared signals obtaining unit 440 and an image signal obtaining unit 430.

The microwave signal obtaining unit 410 may be configured to obtain a signal from the microwave sensor. The microwave signal obtaining unit 410 may be communicatively coupled to one or more microwave sensors. The microwave signal obtained by the microwave signal obtaining unit 410 may be a microwave signal outputted from the microwave sensor, or a signal generated by preprocessing the above signal. In some embodiments, the microwave signal obtained by the microwave signal obtaining unit 410 may be an analog signal or a digital signal. In some embodiments, the analog signal may have a voltage waveform.

In some embodiments, the waveform of a microwave reflected by a stationary object may be steady or change slightly with time. In some embodiments, the amplitude and frequency of a returned microwave signal reflected by a moving object may change with time. The variation of the microwave signal over time may relate to the moving state of the object (e.g., direction, velocity, or acceleration). In some embodiments, the microwave signal obtaining unit 410 may preprocess the obtained microwave signal and then transmit it to the processor 220 for further processing or logic analysis.

The image signal obtaining unit 430 may be configured to obtain a signal of an image sensor. The image signal obtaining unit 430 may communicate with one or more image sensors and obtain image signals generated by the one or more image sensors. In some embodiments, the image signal may be an image formed using the visible light. In some embodiments, the image signal may be an image formed using visible light assisted by electromagnetic waves of other frequency bands, such as an image formed by an infrared-sensor-assisted image sensor. An image sensor may be associated with one or more lenses. In some embodiments, there may be a plurality of image sensors, which may be associated with a plurality of lenses. In some embodiments, a plurality of image sensors associated with a plurality of lenses may be used to obtain information on the surrounding environment, which may include a distance of the object. In some embodiments, an infrared sensor and one or more image sensors associated with lenses may also be used to obtain the information on the surrounding environment. In some embodiments, the image signal obtained by the image signal obtaining unit 430 may be a digital image.

In some embodiments, the image information obtained by the image signal obtaining unit 430 may include information on the surrounding environment within a predetermined angle. Such an angle may relate to the imaging angle of the image sensor. In some embodiments, the imaging angle may be any angle from 0 to 360 degrees. In some embodiments, the imaging angle may be 135 degrees. In some embodiments, the imaging angle may be 180 degrees.

The infrared signal obtaining unit 440 may obtain a signal of an infrared sensor. The infrared signal obtaining unit 440 may obtain infrared signals of the surrounding environment by establishing a communication connection with the infrared sensor. The infrared signal may relate to thermal radiations of objects in the surrounding environment. In some embodiments, by adopting a calibration technique, the thermal radiations of the objects in the environment may be linked to the temperature, and an infrared image of the object may be obtained. In some embodiments, the obtained infrared image may be a temperature distribution image of the corresponding object. In some embodiments, an infrared image may be used to separate an object with a higher temperature from the background environment or an object with a lower temperature. In some embodiments, the infrared signal obtaining unit 440 may preprocess the obtained infrared signal and transmit it to the processor 220 for further processing or analysis.

The infrared signal received by the infrared signal obtaining unit 440 may be obtained from an infrared imager, an infrared thermometer, an infrared radiometer, an infrared scanner, etc. The received infrared signal may be short-wave infrared (wavelength 1˜2.5 micron), medium-wave infrared (wavelength 3˜5 micron), long-wave infrared (wavelength 8˜14 micron), or an infrared signal in another frequency band.

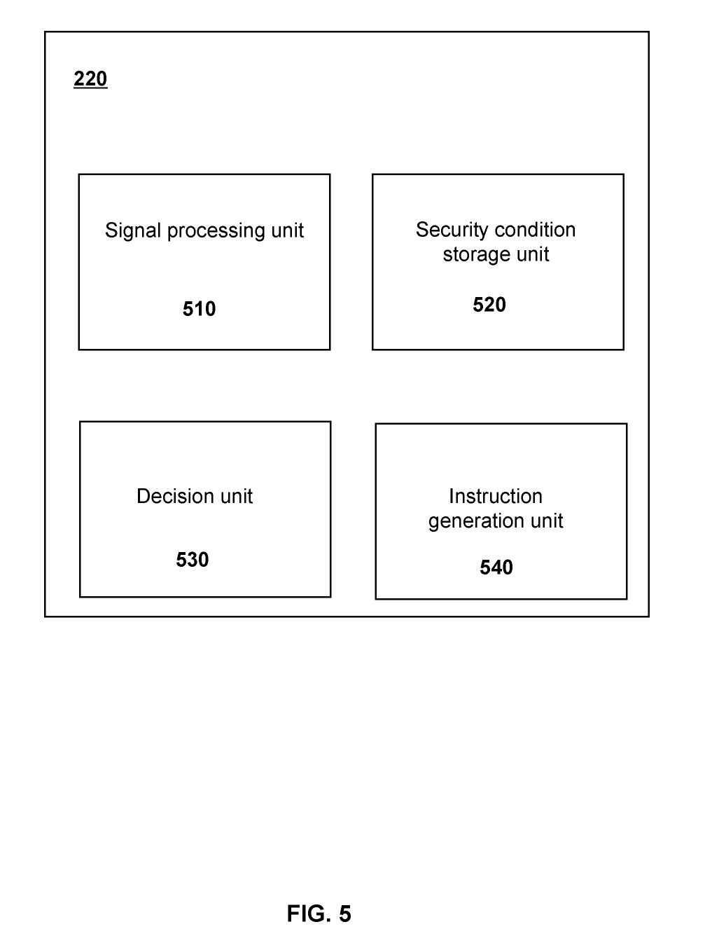

FIG. 5 is a schematic diagram of a processor according to some embodiments of the present disclosure. The processor 220 may include a signal processing unit 510, a security condition storage unit 520, a decision unit 530, and an instruction generation unit 540.

The signal processing unit 510 may process signals obtained by the security system 100. The signal processing unit 510 may receive a signal obtained by the detection module 210. The signal may be a microwave signal, an image signal, an infrared signal, an audio signal, an ultrasonic signal, a gas signal, or the like, or a combination thereof. In some embodiments, the signal processing unit 510 may also obtain a signal through the I/O interface 230. For example, when the security system 100 initiates an intervention, it may perform an identity authentication by obtaining some image signals or other signals of the intruding object. The obtained image signals or other signals may include a facial image, a fingerprint image, a retina image, a voiceprint signal, or the like, or a combination thereof.

The signal processing unit 510 may process the above signal and extract valid information using one or more approaches. The one or more processing approaches may include a numerical computation, a waveform processing, an image processing, or the like, or a combination thereof. The numerical computation may include a principal component analysis, a fitting, an iteration, a discretization, an interpolation, or the like, or a combination thereof. The waveform processing may include an analog-to-digital conversion, a wavelet transformation, a Fourier transformation, a low-pass filtering, or the like, or a combination thereof. The image processing may include recognition of a moving object, an image segmentation, an image enhancement, an image reconstruction, a non-uniformity correction, a detail enhancement for infrared digital images, or the like, or a combination thereof. In some embodiments, with the above approaches, the signal processing unit 510 may process a microwave signal. The processing result may include a determination whether there is a moving object in the environment, information on a fixed frequency component of the moving object, and a frequency-domain signal obtained after filtering out the fixed frequency component, etc. In some embodiments, the signal processing unit 510 may process an image signal. The processing result may include a texture feature, a shape feature, a contour feature, etc., of the image. In some embodiments, the signal processing unit 510 may process an infrared image. The processing result may include a color feature, a contour feature, etc., of the image.

In some embodiments, the signal processing unit 510 may include a microprocessor, a single-chip microcomputer, a tablet computer, a general computer, or a specially designed processing element or device having a special function.

The security condition storage unit 520 may store security condition information. The information may be provided to the decision unit 530 of the processor to determine whether there is a security risk in the surrounding environment, such as a human intrusion. The security condition information stored in the security condition storage unit 520 may be a numerical range or threshold, a time/frequency-domain feature of a microwave signal or a sound signal, color, texture, shape, or contour of the image, or the like, or a combination thereof. In some embodiments, the security condition information may include that there is no moving object, the aspect ratio of contour of the object is less than 1, the temperature of the object is lower than 36° C., the object is regularly moving, the contour in the image doesn't belong to human, the facial feature matches data in a database, the sound feature matches data in a database, or the like, or a combination thereof. In some embodiments, the security conditions may include a primary security condition and one or more secondary security conditions. In some embodiments, the primary security condition may relate to a human intrusion. For example, the primary security condition may be that no moving object is detected. Based on the determination of the primary security condition, security system 100 may initiate one or more functions. In some embodiments, when the primary security condition is violated, the security system 100 may start to analyze the obtained plurality of signals to determine whether there is a human intrusion or a misjudgment. In some embodiments, the one or more secondary security conditions may be associated with non-human intrusion factors that may affect the security system 100, such as regularly moving fans, moving pets at home, swinging curtains, shaking plants, etc. When one or more secondary security conditions are satisfied, one or more corresponding factors may be ruled out.

The security condition storage unit 520 may use one or more storage media that may be read or written, which may include but not limited to, e.g., a static random access memory (SRAM), a random-access memory (RAM), a read-only memory (ROM), a hard disk, a flash memory, etc. In some embodiments, the security condition storage unit may be a local storage device, an external storage device, a storage device communicatively connected by the network 140 (such as a cloud storage device), etc., of the security system.

The decision unit 530 may make a judgment on the signal processing result or user input, and generate decision information. The decision unit 530 may determine the security level of the surrounding environment based on the result generated by the signal processing unit 510, and generate corresponding decision information. In some embodiments, the decision unit 530 may compute and process the information from the signal processing unit 510, and compare it with the security condition information stored by the security condition storage unit 520 to determine whether one or more security conditions are satisfied or violated, so as to determine the current security level. In some embodiments, the decision unit 530 may make follow-up decision information based on the current security level. For example, when determining that the current security level is the threat level, the decision unit 530 may make follow-up decision information to track or lock the target object.

The decision unit 530 may also make decisions based on information or instructions entered by a user via the I/O interface 230 or the mobile device 150. For example, when the user requests image information of a monitored region through the mobile device 150, the decision unit 530 may generate decision information for transmitting the image information of the monitored region received by the image signal obtaining unit 430 to the mobile device 150.

The decision unit 530 may include a programmable logic device (PLD), an application specific integrated circuit (ASIC), a central processing unit (CPU,), a single-chip microcomputer (SCM), a system on a chip (SoC), or the like.

The instruction generation unit 540 may generate control instructions executable by the security system 100 or an external device based on the decision information generated by the decision unit 530. The control instructions may include operation information and address information. The operation information may indicate the approach and function of the operation. The address information may refer to the object of the operation. In some embodiments, the instruction generated by the instruction generation unit 540 may be sent to one or more sensors 110 to cause the corresponding sensors 110 to obtain the environment information. In some embodiments, the control instructions sent to the sensor 110 may also control the switch of the sensor 110, adjust the parameters of the sensor 110, adjust the angle and orientation of the sensor 110 for acquiring signals, etc. In some embodiments, the instructions generated by the instruction generation unit 540 may be sent to the I/O interface 230 to launch the user interface, retrieve the input of a user, or output certain processed information to the user.

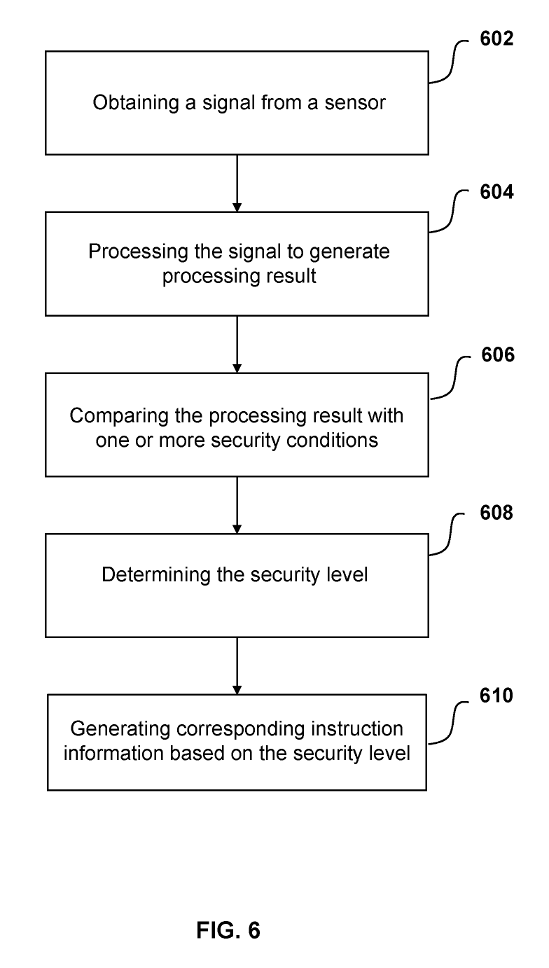

FIG. 6 is a schematic flow chart of an exemplary security monitoring operation according to some embodiments of the present disclosure. Operation 602 may include obtaining, by the processor 220, the surrounding environment information from the sensor 110. Signals obtained by the processor 220 may include a microwave signal, an infrared signal, an image signal, an audio signal, etc. The signal obtained by the processor 220 may be an unprocessed signal outputted by the sensor 110, or a signal generated after preprocessing the above signal (such as a voltage or current signal generated after the preprocessing). In some embodiments, the processor 220 may preferentially obtain a microwave signal. After one or more predetermined conditions are satisfied, the processor 220 may obtain signals of any other sensor. In some embodiments, the condition may be that a microwave signal or its processing result violates a primary security condition.

Operation 604 may include processing, by the processor 220, the obtained signal to generate processing result information. The processor 220 may process different types of signals using one or more different approaches. In some embodiments, the processor 220 may process the microwave signal using one or more approaches to obtain the moving state of a target object. The one or more processing approaches may include a Fourier transformation, a wavelet transformation, a Z transformation, a low-pass filtering, an analog-to-digital conversion, or the like, or a combination thereof. The processing result of the microwave signal generated by the processor 220 may include a determination whether there is a moving object in the environment, frequency information associated with the environment (e.g., information on a fixed frequency component of the moving object, a frequency-domain signal obtained after filtering out the fixed frequency component), etc.

In some embodiments, the processor 220 may process the image signal by one or more approaches to extract image features and/or perform an image recognition. The one or more processing approaches may include a recognition of moving objects, an image enhancement, an image reconstruction, an image segmentation, a geometric processing, an arithmetic processing, an image restoration, an image encoding, or the like, or a combination thereof. The recognition of moving objects may be achieved using one or more image processing approaches including, e.g., an inter-frame difference approach, a background difference approach, an optical flow approach, an edge detection, a hybrid Gaussian model approach, or the like, or a combination thereof. The image enhancement may include histogram enhancement, pseudo color enhancement, grayscale window, or the like, or a combination thereof. The image reconstruction may include algebraic computation, iteration, Fourier back-projection, convolution back-projection, or the like, or a combination thereof. The image segmentation may include region-based segmentation, morphological watershed-based segmentation, or the like, or a combination thereof. After the processing, the processor 220 may generate a result including one or more features of the above image. The one or more features may include a contour shape, a color, a texture, a region shape, a spatial relationship, or the like, or a combination thereof. In some embodiments, the processor 220 may use the above processing approaches to obtain the contour of the moving object. In some embodiments, the processor 220 may process the identification information of the user with the above processing approaches. In some embodiments, the identification information may be a face image, a fingerprint image, a retina image, etc.

In some embodiments, the processor 220 may process the infrared signal using a non-uniformity correction, a detail enhancement for infrared digital images, or the aforementioned processing approaches. The non-uniformity correction may include a calibration-based correction approach and a scene-based correction approach. The detail enhancement for infrared digital images may include a histogram equalization (HE), an unsharp masking (UM), and an image enhancement for simulating human visual characteristics. The processing result generated by the processor 220 may include a color feature, contour information, etc., of the image.

In some embodiments, the processor 220 may process the microwave signal first. After a predetermined condition is satisfied, other signals may also be processed. In some embodiments. The predetermined condition may be that the primary security condition is violated.

Operation 606 may include comparing, by the processor 220, the processing result with one or more security conditions to determine whether the one or more security conditions are satisfied or violated. In some embodiments, the security conditions may include a primary security condition and one or more secondary security conditions. In some embodiments, the primary security condition may be used to determine whether there is a moving object in the surrounding environment. In some embodiments, the obtained microwave signal may be a voltage waveform. When the amplitude of the voltage waveform is greater than a predetermined threshold, the security system 100 may determine that there is a moving object in the surrounding environment, which may violate the primary security condition. In some embodiments, the threshold may be 700 mV. In some embodiments, the one or more secondary security conditions may be used to rule out factors that may affect the decision of the security system 100. These factors may include rotating fans, oscillating pendulums, swaying plants, etc. In some embodiments, the one or more secondary security conditions may include the presence of a fixed frequency component, an aspect ratio of the contour of the image less than 1, a match of audio information match, a match of fingerprint image, a match of retina image, or the like, or a combination thereof. For example, in some scenarios, the security system 100 may perform a Fourier transformation on the microwave signal of the moving object in the environment, and the frequency spectrum may only include one fixed frequency (or be referred to as fixed frequency information, fixed frequency signal), then the primary security condition may be violated but a secondary security condition may be satisfied. As another example, the security system 100 may process the obtained optical image information using an inter-frame difference approach, and the contour of the extracted moving object may match with a contour of a human body in the database. A failure of such a match may satisfy a secondary security condition. With such a secondary security condition, the possibility that the moving object is a human body may be determined to be ruled out.

In some embodiments, the processor 220 may only obtain and process a microwave signal before the primary security condition is violated. In some embodiments, after the primary security condition is violated, the processor 220 may start to process other signals and compare the result with one or more secondary security conditions to determine whether the one or more secondary security conditions are satisfied. In some embodiments, when the result generated by the processor 220 violates the primary security condition, instruction information may be generated to initiate one or more sensors 110. The one or more sensors 110 may include an infrared sensor, an image sensor, a sound sensor, etc.

Operation 608 may include determining, by the processor 220, the current security level according to the above determination. In some embodiments, a security level may correspond to one or more security conditions. In some embodiments, a security level may be determined when the primary security condition is violated. For example, the security system 100 may identify a moving object according to the processing result of the microwave signal, which may violate the primary security condition. When no secondary security condition is satisfied, the security level may be determined as the intrusion mode. In some embodiments, a security level may be determined when the primary security condition is violated and one or more secondary security conditions are satisfied. In some embodiments, after the primary security condition is violated, the processor 220 may compare the processing result with preset security conditions sequentially, and determine a security level after the comparison with all the security conditions is completed. In some embodiments, the processor 220 may compare the processing result with one or more designated security conditions to determine a security level.

Operation 610 may include generating, by the processor 220, corresponding instruction information based on the current security level. The instruction information may be received and executed by the corresponding hardware. In some embodiments, when the current security level is the intrusion mode and the intervention of the security system 100 fails, the processor 220 may generate instruction information or alarm signal. In some embodiments, the instruction information may be sent to the alarm 130. In some embodiments, when the processor 220 determines that there is an intrusion, the alarm 130 may alert locally or remotely, and some security operations may also be executed as well. In some embodiments, according to the instruction information, the alarm may be in the form of a siren or flashlight, such as high-decibel beeping. In some embodiments, the alarm may also include contacting security or the police through the network according to the instruction information. In some embodiments, the alarm 130 may also execute some security operations according to the instruction information, such as locking doors and windows (e.g., locking the doors and windows of the intrusion region), turning on an illumination system, etc.

It should be noted that the above description of the security monitoring workflow is only a specific embodiment and should not be considered as the only feasible solution. Obviously, those skilled in the art, after understanding the basic principles, may make various modifications and changes to the security monitoring workflow or algorithm in form and details without departing from it. However, these corrections and changes are still within the scope of the above description.

In some embodiments, an approach that determines the security level by combining a primary security condition with one or more secondary security conditions may be replaced by other approaches. In these approaches, a dangerous condition or a combination of dangerous conditions may correspond to a security level. The security system 100 may determine a security level if the signal processing result satisfies one or more dangerous conditions. For example, when a first dangerous condition that the aspect ratio of the contour is greater than 1 and a second dangerous condition that a temperature obtained by infrared thermal imaging is higher than 36° C. are both satisfied, or when a first dangerous condition that an object is moving irregularly and a second dangerous condition that a contour in the image matches with a human contour are both satisfied, the security system 100 may determine that the security level is the intrusion mode. As another example, when there is a dangerous condition that the facial feature does not match or the sound feature does not match, the security system 100 may determine that the security level is the threat mode.

In some embodiments, the above primary security condition may be one of the following security conditions: an absence of an object having a temperature greater than 36° C. in the infrared signal, an absence of a human contour in the image information, an aspect ratio of contour less than 1 in the image information, or the like, or a combination thereof. In some embodiments, when the processing result of the security system 100 violates the primary security condition, the current security level may be set as the threat mode, and the other processing results may be checked until the final security level is determined.

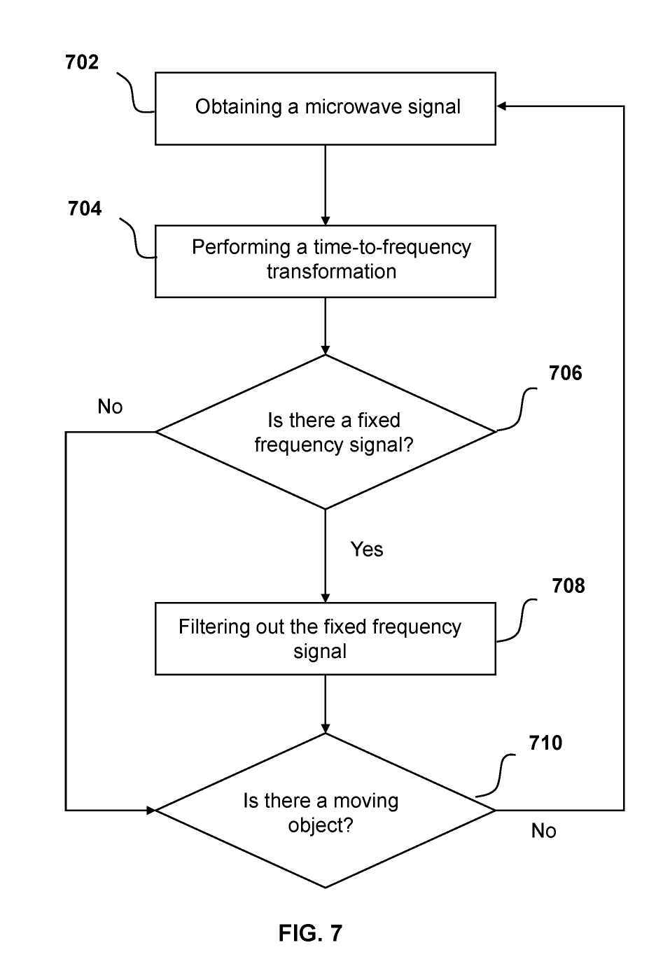

FIG. 7 is a flowchart illustrating an exemplary process for processing a microwave signal according to some embodiments of the present disclosure. Operation 702 may include obtaining, by the security system 100, a microwave signal. The microwave signal reflected by one or more objects in the surrounding environment obtained by the security system 100. In some embodiments, the objects in the surrounding environment may be stationary objects. The waveform of the obtained microwave signal in the time domain may be relatively stable or slightly changed with time without changing the frequency. In some embodiments, the surrounding environment may include one or more moving objects. The amplitude and frequency of the microwave signal may change according to the moving property of the moving object. The microwave signal obtained by the security system 100 may be an analog signal, or a digital signal obtained via a signal processing. In some embodiments, the signal processing may be an analog-to-digital conversion.

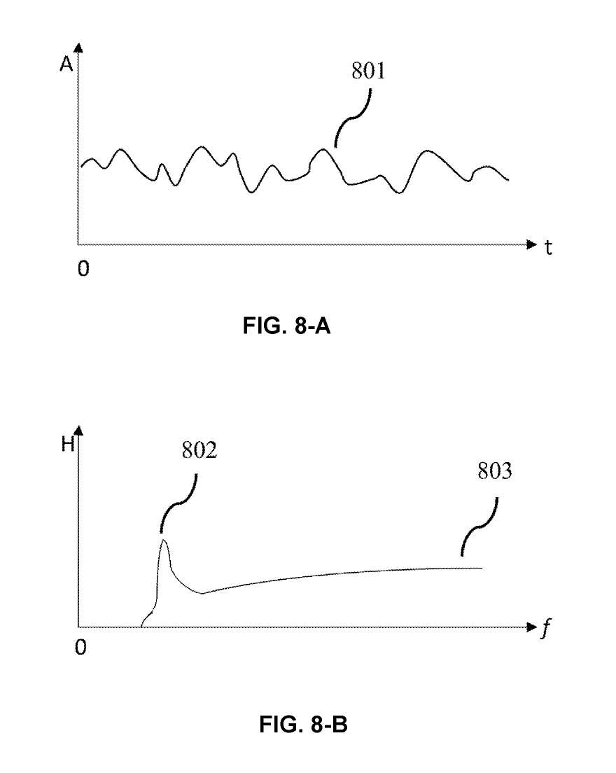

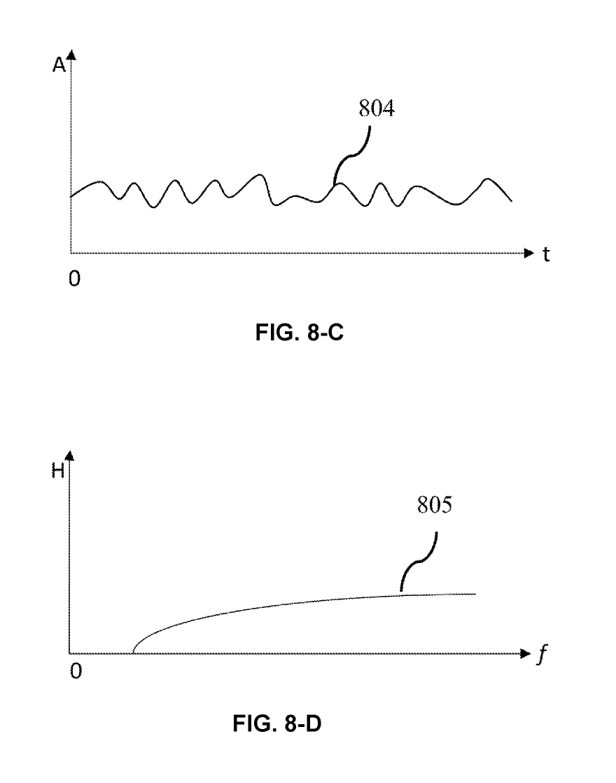

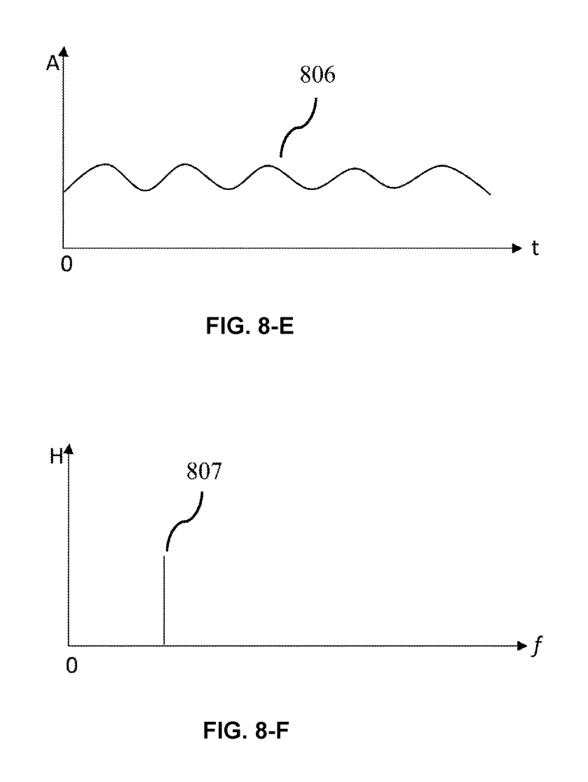

Operation 704 may include performing a time-to-frequency transformation on the obtained microwave signal. The security system 100 may transform the obtained microwave signal in the time domain into a frequency-domain signal in the frequency domain using a transformation approach. The transformation approach may include a Fourier transformation, a wavelet transformation, a Z transformation, etc. In some embodiments, the security system 100 may preprocess the obtained analog signal and then obtain the frequency-domain signal using the above transformation approach. In some embodiments, the preprocessing may include sampling and discretizing the signal. In some embodiments, the preprocessing may include performing an analog-to-digital conversion on the signal. In some embodiments, the microwave signal obtained by the security system 100 is a digital signal, which may be converted into a signal in the frequency domain directly via a Fourier transformation. FIGS. 8-A to 8-F may include detailed descriptions of processing a microwave signal using a Fourier transformation.

FIGS. 8-A through 8-F provide schematic diagrams illustrating an exemplary spectral analysis of a microwave signal using a Fourier transformation according to some embodiments of the present disclosure. The security system 100 may obtain a microwave signal of the surrounding environment through the sensor 110 (e.g., a microwave sensor). In some embodiments, the microwave signal may have a time-domain waveform 801, as shown in FIG. 8-A. By performing a Fourier transformation on the microwave signal, the time-domain waveform 801 may be converted to a frequency-domain waveform 803, as shown in FIG. 8-B. The Fourier transformation may be a continuous Fourier transformation, a discrete Fourier transformation, a short-time Fourier transformation, or a fast Fourier transformation. In some embodiments, the frequency-domain waveform 803 may be obtained by discretizing the time-domain waveform 801 and then performing a discrete Fourier transformation or a fast Fourier transformation. The spectrum of the frequency-domain waveform 803 may include a peak signal 802. After separating the peak signal 802 from the spectrum, the frequency-domain waveform 803 may become the frequency-domain signal 805 as shown in FIG. 8-D. The time-domain signal corresponding to the frequency-domain signal 805 may be the time-domain signal 804 as shown in FIG. 8-C. The peak signal 802 may correspond to the fixed frequency signal 807 as shown in FIG. 8-F. The fixed frequency signal 807 may correspond to the time-domain signal 806 as shown in FIG. 8-E. The frequency-domain signal 805 may correspond to an object moving irregularly, such as a person, an animal, a curtain, etc. The fixed frequency signal 807 may correspond to an object moving regularly, such as a fan, a pendulum clock, or the like. In some embodiments, the spectral analysis of the microwave signal may be achieved by computation by a computer program or software, such as MATLAB, or be implemented by a component or device for spectrum analysis, such as a spectrum analyzer.

Refer back to FIG. 7. Operation 706 may include determining whether there is a fixed frequency signal in the frequency-domain signal. In some embodiments, when there is a fixed frequency signal in the frequency-domain signal, the corresponding secondary security condition may be satisfied, and the influence of a regular moving object on the security system 100 may be eliminated. According to the above frequency-domain analysis, when there is a fixed frequency signal in the frequency-domain signal, the fixed frequency signal may be filtered out in operation 708. The filtering the fixed frequency signal may be implemented by a computer program or software (e.g., MATLAB) or by a physical component or device (e.g., a notch filter).

If there is no fixed frequency signal in the microwave signal or the existing fixed frequency signal has been filtered out in operation 708, then in operation 710, the security system 100 may determine whether there is still a moving object in the surrounding environment. In some embodiments, by comparing the microwave signal obtained after filtering the fixed frequency signal with the microwave signal outputted by the microwave sensor, when there is information on another frequency, it may be determined that there is another irregular moving object, such as an intruding person, an intruding animal, a fluttering curtain, a swinging plant, etc. In some embodiments, when there is a moving object in the surrounding environment, the primary security condition may be violated. In some embodiments, when the processing result of the microwave signal violates the primary security condition, the security system 100 may start to compare the processing result with secondary security conditions.

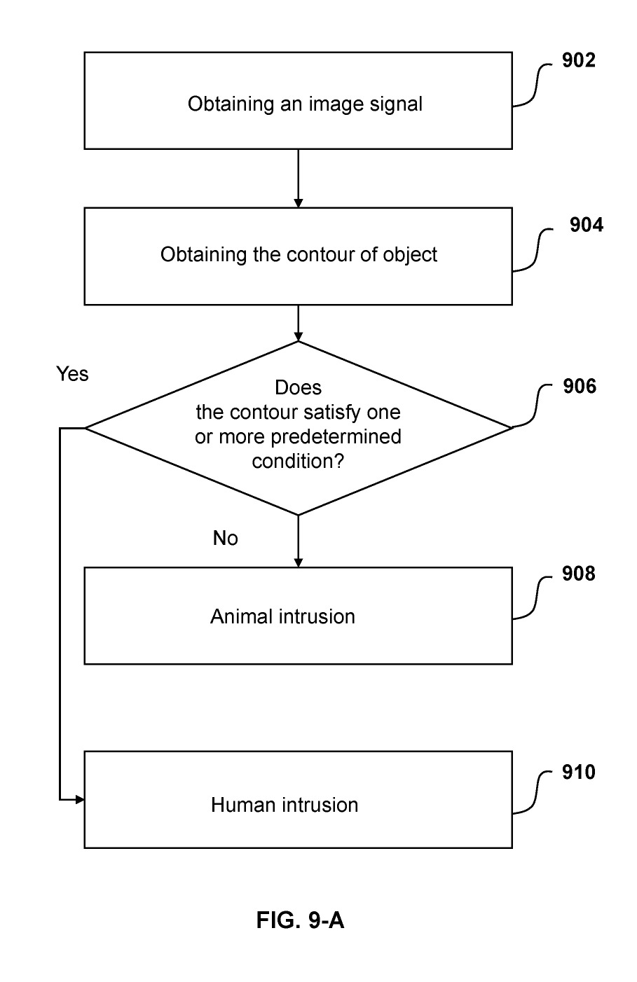

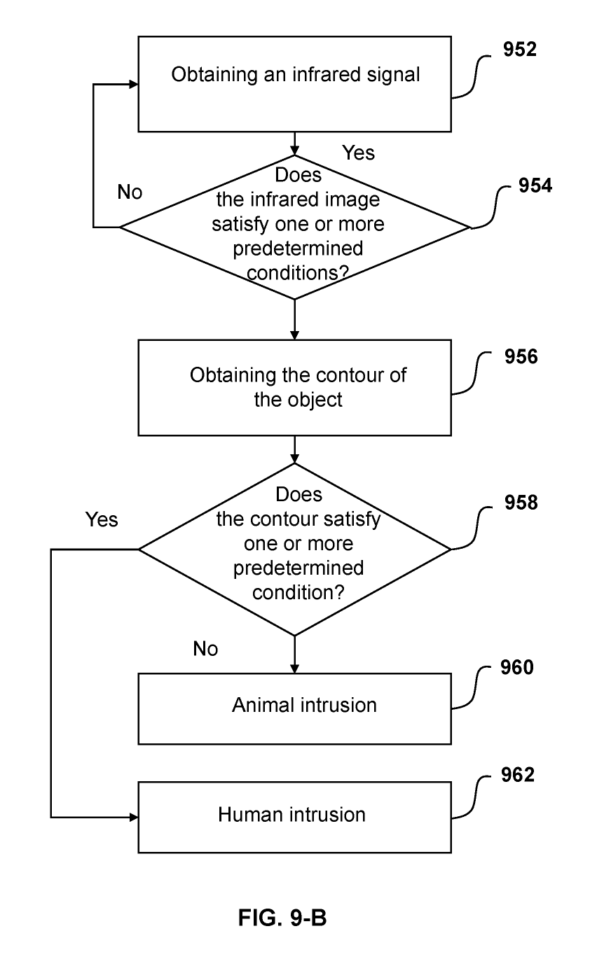

FIG. 9-A is a flowchart illustrating an exemplary process for processing an image obtained based on an image signal according to some embodiments of the present disclosure. Operation 902 may include obtaining, by the security system 100, an image signal generated by the image sensor. The image signal may be formed using visible light or visible light assisted by any other light source. In some embodiments, an image signal formed using visible light may be provided by an image sensor associated with one or more lenses. In some embodiments, the image signal may also be provided by a plurality of image sensors associated with a plurality of lenses. In some embodiments, the image signal formed using visible light assisted by any other light source may be provided by an infrared sensor and one or more image sensors associated with one or more lenses together. The image obtained by the security system 100 may include a stationary object, a moving object, etc. In some embodiments, the image obtained by the security system 100 may include one or more moving objects. The image signal at the current stage may be twisted or distorted. The security system 100 may preprocess the image signal using one or more approaches. The one or more preprocessing approaches may include panoramic distortion correction, distortion correction, pseudo color enhancement, histogram enhancement, subtraction, Fourier back-projection, convolution back-projection, or the like, or a combination thereof.

In operation 904, the security system 100 may obtain contour information of an object. The approach for obtaining the contour information of the object may include a boundary feature approach, a Fourier feature description approach, an inter-frame difference approach, a background difference approach, a mixed Gaussian model approach, an optical flow approach, an edge detection approach, or the like, or a combination thereof. The contour of a moving object may be obtained by one or more image processing approaches, e.g., the inter-frame difference approach, the background difference approach, the mixed Gaussian model approach, the optical flow approach, and the edge detection approach, etc. In some embodiments, the security system 100 may obtain the contour information of a moving object using an inter-frame difference approach. In some embodiments, in the inter-frame difference approach, to obtain the contour information of a moving object, a difference operation may be performed on images including the moving object obtained at different time points.

Operation 906 may include determining whether the contour information of above objects satisfies one or more predetermined conditions. In some embodiments, the one or more conditions may include that whether the contour is a predetermined shape, the aspect ratio is within or out of a specific range, or the like, or a combination thereof. In some embodiments, the above shape or range may be set according to contours of a human body, a pet, or any other animals. In some embodiments, the security system 100 may determine whether the contour of the object is a contour of human or whether the aspect ratio of the contour satisfies that of the contour of a human. In some embodiments, the security system 100 may determine whether the aspect ratio of the contour of the object is above a threshold. For example, the threshold may be a positive number such as 0.5, 0.8, 1, 1.5.

When the contour of the object does not satisfy the given condition, the process may proceed to operation 908, and the security system 100 may determine that there is an animal intrusion. In some embodiments, the security system 100 may determine that the animal intrusion satisfies the corresponding secondary security condition, and the influence of animals on the determination of the security system 100 may be eliminated. In some embodiments, according to the fact whether there is a pet in the family, the user may determine whether the secondary security condition is satisfied when the security system 100 determines that there is an animal intrusion. For example, when there is no pet in the family, the user may cancel the secondary security condition. When an animal is detected, the security system 100 may perform specific operations including alarming. In some embodiments, after an animal intrusion is determined, the security system 100 may alert via a buzzer. In some embodiments, the security system 100 may use a buzzer, a flashlight, etc., to drive the intruding animal away. In some embodiments, the security system 100 may lock doors and windows of the intruded region to limit the intruding animal within the region.

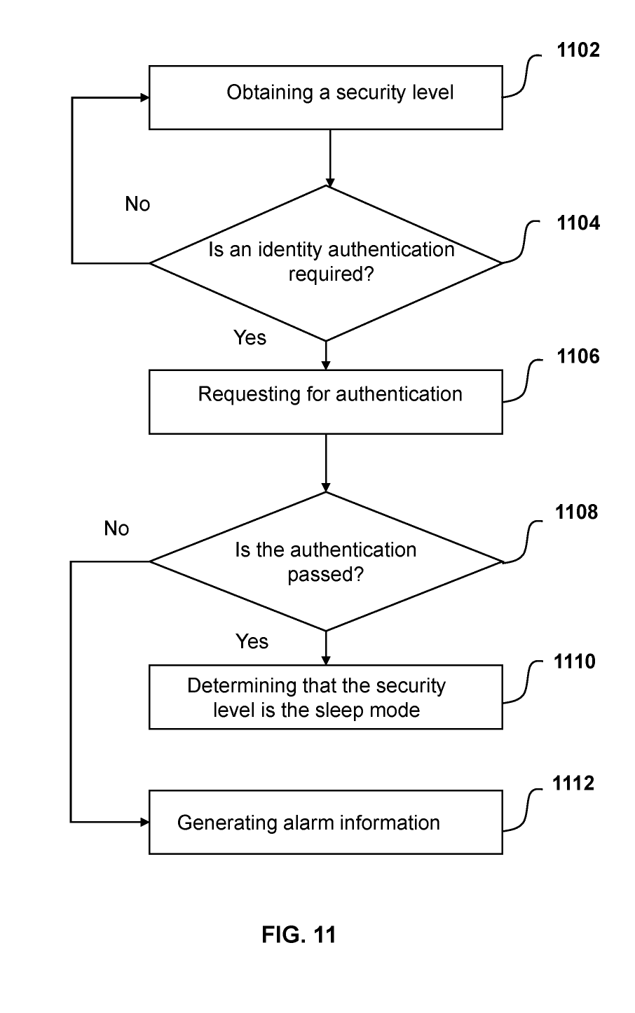

When the obtained aspect ratio is less than the threshold, the process may proceed to operation 910. The security system 100 may determine that there is a human intrusion and initiate the intervention mode. Detailed descriptions of the intervention of the security system 100 may be found elsewhere in the present disclosure, such as FIG. 11 and the descriptions thereof.

FIG. 9-B is a flowchart illustrating an exemplary process for of processing an image obtained based on an infrared signal according to some embodiments of the present disclosure. In operation 952, the security system 100 may obtain an infrared signal generated by an infrared sensor. The security system 100 may obtain thermal radiations generated by the object through the infrared sensor. In some embodiments, the energy distribution of the radiation of the object may be captured by a specific component, such as a photosensitive element, to obtain an infrared signal. The infrared signal may correspond to the heat distribution on the surface of the object. By calibrating the infrared signal, the heat distribution on the surface of the object may correlate with the temperature. In some embodiments, the infrared signal may be presented in the form of an infrared image. By calibrating the infrared signal, the heat distribution of the object may be reflected by the color information of the image. In some embodiments, via a temperature calibration, in the infrared image, the color corresponding to human bodies or animals may be red, and the color corresponding to plants, furniture, etc., may be blue.

In some embodiments, the security system 100 may preprocess the obtained infrared signal via one or more approaches. The one or more preprocessing approaches may include one or more approaches for processing infrared signals, such as non-uniformity correction, detail enhancement for infrared digital images, or one or more aforementioned approaches for preprocessing an image signal. The non-uniformity correction may include a calibration-based correction approach and a scene-based correction approach, etc. The detail enhancement for infrared digital images may include a histogram equalization (HE), an unsharp masking (UM), and an image enhancement approach that simulates human visual characteristics, etc.

In operation 954, the security system 100 may determine whether the infrared image satisfies one or more predetermined conditions. The one or more conditions may include whether there is an object having a temperature above a predetermined threshold/range in the infrared image. The threshold or range may be set according to the temperature of the human body or animal body. For example, the threshold may be set as 36° C., or between 35 and 40° C., etc. The threshold may be set by the user, preset as system default values, adaptively adjusted by the system, etc. In some embodiments, the threshold may relate to the temperature calibration. The security system 100 may adaptively adjust the temperatures of the objects in the image by obtaining factors that may affect the temperature calibration, such as air humidity, surrounding temperature, the angle between the infrared sensor and the surface of the object, etc.

When the security system 100 determines that the obtained infrared image does not satisfy the one or more conditions, the security system 100 may determine that there is no person or animal in the surrounding environment, and the corresponding secondary security condition may be satisfied. Correspondingly, the process may return to operation 952, and the security system 100 may continue obtaining temperatures of objects in the environment and comparing it with the one or more preset conditions. When it is determined that the obtained infrared image satisfies the one or more conditions, the security system 100 may determine that a person or an animal exists in the surrounding environment, and the corresponding secondary security condition may not be satisfied. Correspondingly, the process may proceed to operation 956 to obtain the contour of the object(s) in the infrared image. In some embodiments, the security system 100 may obtain the contour of the object in the infrared image via one or more contour feature extraction approaches, such as the aforementioned boundary feature approach, the Fourier feature description approach, the inter-frame difference approach, the background difference approach, the mixed Gaussian model approach, the optical flow approach, the edge detection approach, etc. In some embodiments, the security system 100 may extract and process color features in the infrared image to obtain the contour of the object in the infrared image. For example, according to the characteristic that different colors in the infrared image correspond to different temperature, the security system 100 may adopt an approach such as a color histogram approach to extract the contour information of a person or an animal. The descriptions of the operations 958, 960, and 962 may be similar to the descriptions of the operations 906, 908, and 910 in FIG. 9-A, respectively, which are not repeated herein again.

It should be noted that, when the security system 100 obtains the surrounding environment information and determines whether there is a human intrusion, the microwave signal described in FIG. 7 may be used in combination with at least one of the optical signals described in FIG. 9-A or FIG. 9-B for determining the security level. In some embodiments, the security level may be determined using the microwave signal and the infrared signal. In some embodiments, the microwave signal related security condition or determination approach may be used as the primary security condition or the primary determination approach, and the infrared signal related security condition or determination approach may be used as a secondary security condition or an approach for eliminating influence factors. For example, whether there is a moving object may be determined using the microwave signal. When there is a moving object, the primary security condition may be violated. In situations that the primary security condition is violated, the security system 100 may sequentially determine whether the moving object satisfies one or more secondary security conditions by checking the processing results. Exemplary secondary security conditions may include that the detected object is moving regularly, the maximum temperature in the infrared image is less than 36° C., and the aspect ratio of a contour in the infrared image is less than 1. In some embodiments, when all the secondary security conditions are not satisfied, the security level may be determined as the intrusion mode. In some embodiments, when the security condition that the moving object is moving regularly or the security condition that the maximum temperature of the object is less than 36° C. is satisfied, the security level may be determined as the caution mode. In some embodiments, when the security condition that the aspect ratio of the contour is less than 1 is satisfied, the security level may be determined as the threat mode, under which the security system 100 may continue tracking and detecting the object.

In some embodiments, the security system 100 may determine that the current security level is the threat mode. In some embodiments, the security system 100 may further determine whether one or more secondary security conditions are satisfied. According to the determination whether the secondary security condition is satisfied, the security system 100 may determine the corresponding security level. In some embodiments, the security system 100 may determine that the current security level is the intrusion mode when only the primary security condition is violated and all the secondary security conditions are not satisfied. In some embodiments, the security system 100 may initiate an intervention procedure and decide whether to alert according to the intervention result.

In some embodiments, the security system 100 may adaptively use or ignore one or more secondary security conditions. For example, when the external brightness is dark and it is difficult to identify the contour of the object, the secondary security condition that the aspect ratio of the contour in the image signal is less than 1 may be ignored.

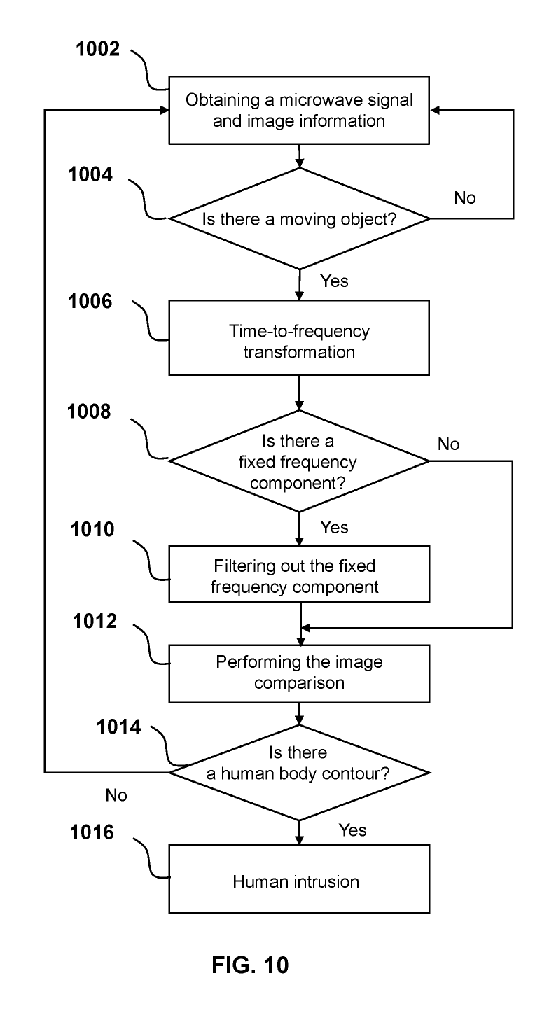

FIG. 10 is a flowchart illustrating an exemplary process for a security system to determine whether there is a human intrusion based on a microwave signal and an image signal by according to some embodiments of the present disclosure. Operation 1002 may include obtaining, by the security system 100, a microwave signal and image information of the surrounding environment. The microwave signal may be a signal reflected by an object in the surrounding environment obtained by the security system 100 through the microwave sensor. The image information may be obtained by the image sensor by capturing visible or infrared light of the surrounding environment. In some embodiments, the microwave signal may be an analog voltage waveform; the image information may be one or more images including the surrounding environment.

In operation 1004, security system 100 may determine whether there is a moving object. In some embodiments, the obtained microwave signal may have a voltage waveform. When the amplitude of the voltage waveform is greater than a predetermined threshold, the security system 100 may determine that there is a moving object in the surrounding environment. In some embodiments, the threshold may be 500 mV, 700 mV, 1000 mV, etc. When the result of the security system 100 determines that there is a moving object in the surrounding environment, the primary security condition may be violated. At this moment the security system 100 may start to compare the signal processing results with one or more secondary security conditions, and the process may proceed to operation 1006. In some embodiments, the security system 100 may check all the secondary security conditions in subsequent operations to determine the current security level. When the security system 100 determines that there is no moving object, the process may return to operation 1002, and the security system 100 may continue monitoring and obtaining microwave signals and image information.

In operation 1006, a time-to-frequency transformation may be performed on a microwave signal including one or more moving objects. In some embodiments, the time-to-frequency transformation may be based on one or more approaches such as Fourier transformation, Z transformation, and wavelet transformation. In some embodiments, the security system 100 may sample and discretize the voltage waveform, and perform discrete Fourier transformation, fast Fourier transformation, or wavelet transformation to transform the obtained time-domain signal into a frequency-domain signal. Operations 1008 and 1010 may include determining and filtering out a fixed frequency component in the frequency-domain signal. The fixed frequency component may correspond to a regularly moving object in the surrounding environment. In some embodiments, there may be a fixed frequency component in the frequency-domain signal. By analyzing the fixed frequency component, whether there is a regularly moving object may be determined, and the influence of regularly moving objects on the monitoring and identifying human intrusion by the security system 100 may be eliminated. In some embodiments, the regularly moving object may include electrical appliances such as a fan, a pendulum clock, a sweeping robot, etc.

When the frequency-domain signal does not include a fixed frequency component, or there is still an object even after the fixed frequency component is filtered out, an image comparison may then be performed in operation 1012. The security system 100 may use one or more image comparison or processing approaches to extract information on the one or more moving objects. In some embodiments, the security system 100 may obtain contour information of the one or more moving objects using an image processing approach such as an inter-frame difference approach, a background difference approach, an optical flow approach, a mixed Gaussian model approach, or an edge detection approach, or the like, or a combination thereof. Operation 1014 may include determining whether the contour information includes a contour of a human body. In some embodiments, by comparing the obtained contour shape or parameter(s) with the shapes or parameters of one or more preset contours in the database, whether the moving object is a human body may be determined. In some embodiments, the shapes or parameters of the one or more preset contours in the database may be set according to different body shapes of people. In some embodiments, the above contour parameter may be the aspect ratio of the contour. In some embodiments, when the aspect ratio of the contour is less than a reference value or a reference range, the corresponding secondary security condition may be satisfied, and the possibility of a human intrusion may be ruled out. Then the security level may be determined as the caution mode, and the process may return to operation 1002. When the aspect ratio of the contour is greater than the reference value or the reference range, then in operation 1016, the security system 100 may determine that there is a human intrusion and initiate an intervention. In some embodiments, the reference value may be a positive number such as 0.5, 0.8, 1, 1.5, etc. In some embodiments, the reference range may be a range such as 0.5-0.8, 0.8-1, 1-1.5, etc. In some embodiments, the security system 100 may perform the intervention on the intruding person in a manner or process as shown in FIG. 11.

FIG. 11 is a flowchart illustrating an exemplary process for initiating an intervention by the security system according to some embodiments of the present disclosure. Operation 1102 may include obtaining, by the security system 100, a security level. The security system 100 may obtain the security level by processing obtained surrounding environment information and comparing the processing result with one or more security conditions. The surrounding environment information may be a microwave signal, an infrared signal, an image signal, and a sound signal of the surrounding environment.

Operation 1104 may include determining, by the security system 100, whether an identity authentication is required. In some embodiments, when the current security level satisfies one or more predetermined conditions, the process may return to operation 1102, and the security system 100 may continue monitoring, obtaining environment information, and obtaining security levels. In some embodiments, the above condition may be that the current security level is one or more of a plurality of security modes, such as the sleep mode or the caution mode. When the security system 100 determines that the identity authentication is required, operation 1106 may be performed. In some embodiments, when the corresponding security level is the threat mode or the intrusion mode, it may be determined that the identity authentication is required.

Operation 1106 may include, when the identity authentication is required for a suspect, prompting and requesting, by the security system 100, the suspect to be authenticated. In some embodiments, the security system 100 may provide a short buffer time, or be referred to as an intervention time. During the intervention time, the suspect may be requested to be authenticated. The approach for authentication may be or may include inputting a password, face recognition, iris recognition, fingerprint registration, answering one or more questions, image selection, gesture representation, voiceprint recognition, etc. In some embodiments, the security system 100 may output prompt information for identity authentication through an I/O interface, which may be configured to prompt the suspect with the content and the manner of the identity authentication. In some embodiments, the prompt information may include, without limitation, a voice, a text, an indicator light, a picture, a number, etc.

Based on the identity authentication information provided by the suspect, in operation 1108, the security system 100 may determine whether the authentication is passed. In some embodiments, the security system 100 may match the information entered by the suspect with the information stored in a database. The information stored in the database may include a password, a fingerprint, a facial feature, an iris feature, a question and/or an answer for authentication, a gesture for authentication, etc.

When the authentication is passed, the process may proceed to operation 1110, and the security system 100 may determine that the current security level is the sleep mode. The sleep mode is suitable for the owner to use at home, and may ensure that the owner is free to move at home without worrying that the alarm is set off by accident and the normal life is affected. When the authentication fails, the process may proceed to operation 1112, and the security system 100 may generate alarm information or alarm signal. In some embodiments, the security system 100 may set off an alarm and execute appropriate security operations. In some embodiments, the security system 100 may turn on lights of all the rooms at the same time to warn the intrusion.

The basic concept has been described above, and it is obvious to those skilled in the art that the disclosure is by way of example only and does not constitute a limitation of the present disclosure. Various alterations, improvements, and modifications to the present disclosure may be made by those skilled in the art, although not explicitly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. In addition, certain features, structures, or characteristics of one or more embodiments of the present disclosure may be combined as appropriate.

Moreover, those skilled in the art will appreciate that aspects of the present disclosure may be illustrated and described by a number of patentable categories or conditions, including any new and useful combinations of processes, machines, products or substances, or any new and useful improvements to them. Accordingly, various aspects of the present disclosure may be performed entirely by hardware, may be performed entirely by software (including firmware, resident software, microcode, etc.) or may be performed by a combination of hardware and software. The above hardware or software may be referred to as “data block”, “module”, “engine”, “unit”, “component” or “system”. In addition, aspects of the present disclosure may be embodied as a computer product located on one or more computer readable media, including a computer readable program code.

A computer readable signal medium may include a propagated data signal with computer readable program code embodied therein, for example, in baseband or as part of a carrier wave. The propagated signal may have a variety of manifestations, including electromagnetic forms, optical forms, and the like, or a suitable combination. A computer readable signal medium may be any computer readable medium that is not a computer readable storage medium and that may communicate, propagate, or transport a program for use by or in connection with an instruction execution system, apparatus, or device. Program code located on a computer readable signal medium may be propagated through any suitable medium, including a radio, cable, fiber optic cable, radio frequency signal, or similar medium, or any combination of the medium.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python, or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, such disclosure of the method does not mean that the present disclosure object requires more features than the features mentioned in the claims. Rather, claim subject matter lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” Unless otherwise stated, “about,” “approximate,” or “substantially” may indicate ±20% variation of the value it describes. Accordingly, in some embodiments, the numerical parameters set forth in the description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each patent, patent application, patent application publication and other materials cited herein, such as articles, books, instructions, publications, documents, etc., are hereby incorporated by reference in their entirety. Application history documents that are inconsistent or conflicting with the contents of the present disclosure are excluded, and documents (currently or later attached to the present disclosure) that limit the widest range of the scope of the present disclosure are also excluded. It is to be noted that whether the description, definition, and/or terminology used in the appended application of the present disclosure is inconsistent or conflicting with the contents described in this application, the description, definition and/or terminology may be subject to the present disclosure.

At last, it should be understood that the embodiments described in the present disclosure are merely illustrative of the principles of the embodiments of the present disclosure. Other modifications may also be within the scope of the present disclosure. Other modifications that may be employed may be within the scope of the application. Thus, by way of example, but not of limitation, alternative configurations of the embodiments of the application may be utilized according to the teachings herein. Accordingly, embodiments of the present disclosure are not limited to the embodiments that are expressly introduced and described herein.

We claim:

1. A system comprising:
a detection module configured to:
receive a microwave signal from a moving object located in an environment; and
obtain at least one optical image including the moving object; and
a processor configured to:
determine frequency information associated with the environment according to the microwave signal,
determine a contour of the moving object according to the at least one optical image, and
determine a security level according to at least a portion of the frequency information and the contour of the moving object.

2. The system of claim 1, wherein the detection module includes an image sensor or an infrared sensor.

3. The system of claim 2, wherein the image sensor is associated with one or more lenses.

4. The system of claim 2, wherein the infrared sensor includes an infrared thermal imager.

5. The system of claim 1, wherein the frequency information includes a fixed frequency associated with the moving object.

6. The system of claim 1, wherein the frequency information is obtained by the processor by performing a Fourier transformation on the microwave signal.

7. The system of claim 1, wherein the contour of the moving object is obtained by the processor by applying an image processing approach to the at least one optical image.

8. The system of claim 7, wherein the image processing approach includes at least one of an inter-frame difference approach, a background difference approach, an optical flow approach, an edge detection approach, or a mixed Gaussian model approach.

9. The system of claim 1, wherein the processor is further configured to determine whether the moving object is a human according to an aspect ratio of the contour of the moving object.

10. The system of claim 1, further comprises an alarm configured to generate an alarm signal when the security level is below a predetermined threshold.

11. A method, comprising:
receiving a microwave signal from a moving object located in an environment;
obtaining at least one optical image including the moving object;
determining, by a processor, frequency information associated with the environment according to the microwave signal;
determining a contour of the moving object according to the at least one optical image; and
determining a security level according to at least a portion of the frequency information and the contour of the moving object.

12. The method of claim 11, wherein the optical image is obtained by an image sensor or an infrared sensor.

13. The method of claim 12, wherein the image sensor is associated with one or more lenses.

14. The method of claim 12, wherein the infrared sensor includes an infrared thermal imager.

15. The method of claim 11, wherein the frequency information includes a fixed frequency associated with the moving object.

16. The method of claim 11, wherein the frequency information is obtained by performing a Fourier transformation on the microwave signal.

17. The method of claim 11, wherein the determining a contour of the moving object comprises:
processing the at least one optical image using at least one of an inter-frame difference approach, a background difference approach, an optical flow approach, an edge detection approach, or a mixed Gaussian model approach.

18. The method of claim 11, further comprising: determining whether the moving object is a human by computing an aspect ratio of the contour of the moving object.

19. The method of claim 11, further comprising:
setting off an alarm, according to an alarm manner, when the security level is below a predetermined threshold.

20. A non-transitory computer readable storage medium storing executable instructions that cause a computing device to execute operations including:
receiving a microwave signal from a moving object located in an environment;
obtaining at least one optical image including the moving object;
determining frequency information associated with the environment according to the microwave signal;
determining a contour of the moving object according to the at least one optical image; and
determining a security level according to at least a portion of the frequency information and the contour of the moving object.
